(19) United States
(12) Patent Application Publication
(10) Pub. No.: US 2026/0369101 A1
(43) Pub. Date: Nov. 19, 2026

(54) SYSTEMS AND METHODS FOR AUGMENTING ACTIONS BASED UPON DETECTED USER EXPRESSIONS

(71) Applicant: Yahoo Assets LLC, New York, NY (US)

(72) Inventors: Mohit Goenka, Santa Clara, CA (US); Nikita Varma, Milpitas, CA (US); Gnanavel Shanmugam, San Jose, CA (US); Ashish K. Dharamshi, Sunnyvale, CA (US)

(21) Appl. No.: 19/206,673

(22) Filed: May 13, 2025

(51) Int. Cl. G06V 40/16; H04L 51/04; H04L 51/216; H04L 51/226; H04N 7/15

(52) U.S. Cl. CPC G06V 40/176; H04L 51/04; H04L 51/216; H04L 51/226; H04N 7/15

(57) ABSTRACT

One or more computing devices and/or methods for augmenting actions based upon detected user expressions are provided. A sensor of a device is controlled to acquire sensor data related to a user. The sensor data is processed to determine an emotional state of the user. Content is generated based upon a type of emotion represented by the emotional state of the user. The content is provided to the user through the device.

### BACKGROUND

Many users write messages, perform tasks, and implement other computer actions while having certain emotional states. For example, a user may be engaging in a chat conversation with a co-worker while experiencing stress over something related to the conversation. The stress may cause the user to write messages with a tone that the user would normally use if the user was not under stress. Similarly, the user may be frustrated over a situation in life unrelated to an email being composed by the user. Because of the frustration, the user may write the email with a more aggressive tone that the user would normally use if the user was not frustrated. Thus, the emotional state of the user may affect actions performed by the user through computing devices.

### SUMMARY

In accordance with the present disclosure, one or more computing devices and/or methods for augmenting actions based upon detected user expressions are provided. A device such as a phone, a smart watch, or other device may include a sensor capable of acquiring sensor data such as images, audio, biometric feedback, etc. The sensor data may be acquired and processed to determine an emotional state of the user, such as whether the user appears to be angry, frustrated, relaxed, energetic, rushed, sad, etc. Content may be generated based upon a type of emotion represented by the emotional state of the user. In some embodiments, the content may include a personalized emoji related to the emotional state of the user, an evaluation or analysis of the emotional state of the user, suggestions related to a message or conversation with which the user is engaged, emotional trends and patterns of the user, reprioritized tasks, commands to modify smart devices, etc. In this way, the computer generated content may be provided to the user.

In some embodiments, the content may be used to augment an action being performed by the user. For example, the user may be writing an email, which is detected as an email creation action. The email creation action may be augmented by suggesting text to replace existing text within the email, suggesting an emoji to include within the email, increasing an email un-send time for the email, suggesting that the user reconsider a tone or sentiment of the email, etc.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for augmenting actions based upon detected user expressions.

FIG. 5 is a component block diagram illustrating an example system for augmenting actions based upon detected user expressions.

FIG. 6 is a component block diagram illustrating an example system for augmenting actions based upon detected user expressions, where an emoji is generated.

FIG. 7 is a component block diagram illustrating an example system for augmenting actions based upon detected user expressions, where emotional state feedback is provided to a user.

FIG. 8 is a component block diagram illustrating an example system for augmenting actions based upon detected user expressions, where emotional trends and personalized journal prompts are provided to a user.

FIG. 9 is a component block diagram illustrating an example system for augmenting actions based upon detected user expressions, where suggested content is provided to a user.

FIG. 10 is a component block diagram illustrating an example system for augmenting actions based upon detected user expressions, where message suggestions are provided to a user.

FIG. 11 is a component block diagram illustrating an example system for augmenting actions based upon detected user expressions, where replacement text is suggested to a user.

FIG. 12 is a component block diagram illustrating an example system for augmenting actions based upon detected user expressions, where tasks are reprioritized for a user.

FIG. 13 is a component block diagram illustrating an example system for augmenting actions based upon detected user expressions, where summarizes of past conversations are provided to a user.

FIG. 14 is a component block diagram illustrating an example system for augmenting actions based upon detected user expressions, where an emotional awareness interface is provided to a user.

FIG. 15 is a component block diagram illustrating an example system for augmenting actions based upon detected user expressions, where a content browsing interface is provided to a user.

FIG. 16 is a component block diagram illustrating an example system for augmenting actions based upon detected user expressions, where a smart device is controlled based upon an emotional state of a user.

FIG. 17 is a component block diagram illustrating an example system for augmenting actions based upon detected user expressions, where media files are tagged based upon detected emotions.

FIG. 18 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

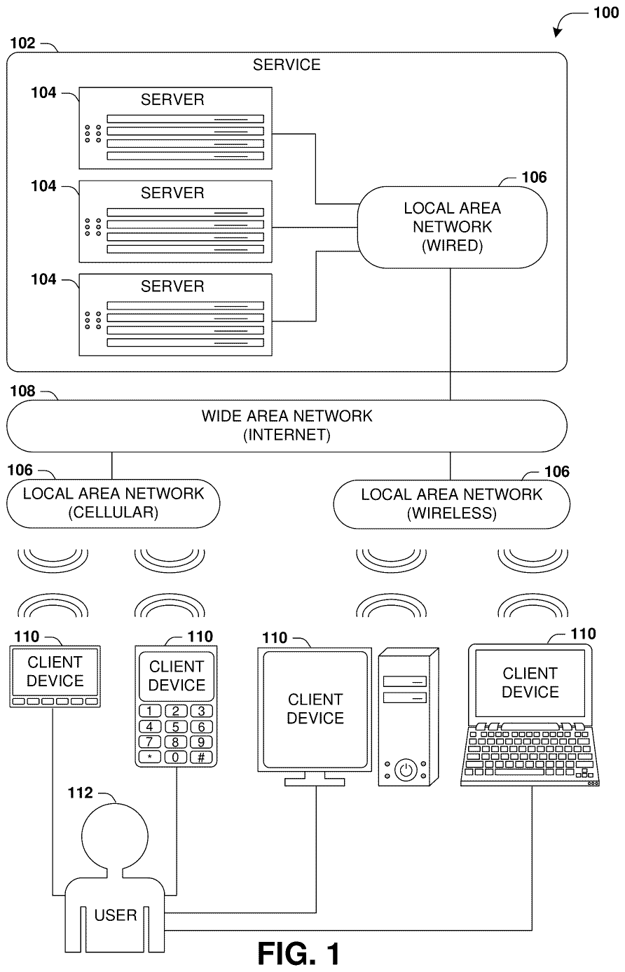

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

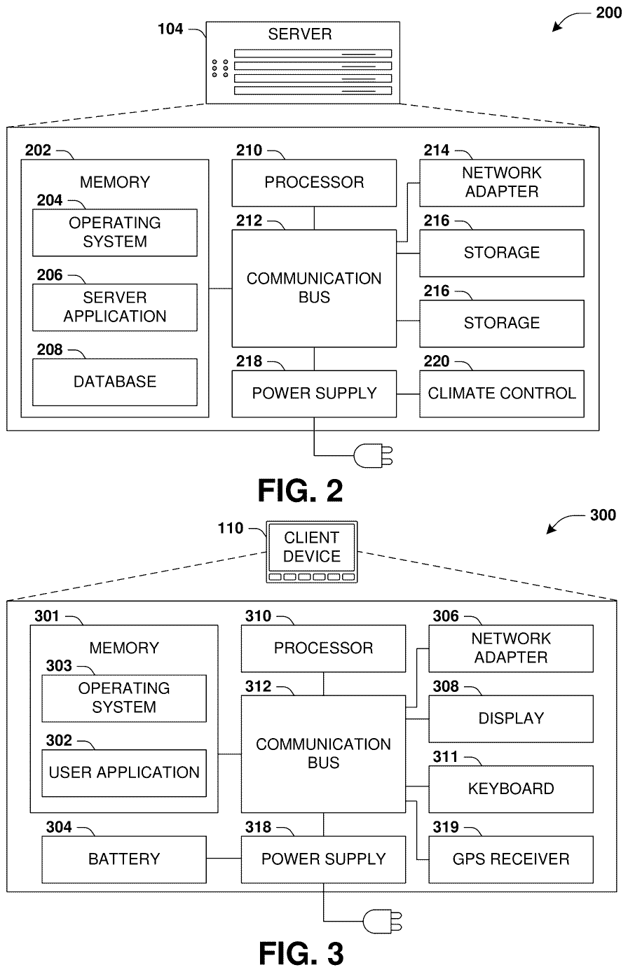

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

Systems and/or techniques for augmenting actions based upon detected user expressions are provided. The system leverages real-time user vitals, facial expressions, gestures, and behavior patterns to contextually augment digital actions, such as on communication and content consumption actions. The system promotes mindful and balanced digital interactions by providing users with intelligent feedback and suggestions based on their physiological and emotional states.

In some embodiments, the system generates expression-based emojis. Utilizing a camera, the system analyzes facial expressions of a user in real time to detect emotions such as joy, sadness, surprise, anger, etc. Based upon the detecting emotions, the system automatically generates personalized emojis that reflect the current emotional state of the user. The custom emojis can be readily used by the user in messages, thus adding a layer of authentic emotional expression to digital communication.

In some embodiments, the system provides for smartwatch driven emoji reactions. Integrating with smartwatch data, the system leverages detected user expressions captured by wearable sensors. The detected data is processed by the system to determine a user's emotional reaction while interacting with digital content. Based upon the emotional reactions, the system can intelligently suggest relevant emojis for the user to insert into messages, thus streamlining the process of expressing emotions online.

In some embodiments, the system provides for facial expression evaluation during video calls. During a video call, the system analyzes (continuously analyzes) the user's facial expressions. If significant changes in facial expressions are detected such as a sign of stress, confusion, or disengagement, then the system can provide the user with discreet, private evaluation of the perceived emotional state. The feedback can help the user become more self-aware of non-verbal communication during virtual interactions, and adjust accordingly.

In some embodiments, the system provides for image capture and emotional change detection. The system may periodically capture images of the user over time, such as based upon user opt-in consent. The images may be analyzed to identify patterns and changes in the user's typical facial expressions and emotional baseline. The system can notify the user of significant shifts in emotional tends, thus prompting self-reflection and potential intervention.

In some embodiments, the system provides for emotional driven journal prompts. The system may journal the user's detected emotions over a time period such as throughout the day. The system correlates timestamps and may link the emotions to specific activities of the user, if known or provided. The journal may be used to generate personalized journal prompts, thus encouraging the user to reflect on triggers and patterns associated with emotional fluctuations.

In some embodiments, the system provides an emotionally informed recommendations engine. When a user is engaged in content consumption such as reading a news article, the system analyzes patterns of engagement and emotional reactions, which may be detected through vitals and facial expressions. The recommendation engine learns from these patterns, and suggestion content such as articles tailored to the user's emotional state. For example, if the user is consistently reacting positive to uplifting content, then the system can prioritize similar uplifting content for the user to consume.

In some embodiments, the system provides for bias neutralization in content consumption. If the system detects that a user is primarily consuming biased content (e.g., heavily skewed news sources), then the system can proactively suggest content representing the other end of the spectrum or neutral content so that the user is provided with balanced information.

In some embodiments, the system provides for emotionally intelligent message un-send time adjustment. The system dynamically adjust a message un-send time for messages based upon the user's detected emotional state. For example, if the system determines through vitals or expressions that the user has a heightened negative emotion such as anger or frustration, then the system automatically increases the message un-send time to provide for a long time window for unsending the message. This provides a buffer by allowing the user to have extra time to reconsider sending a potentially reactive or emotionally charged message.

In some embodiments, the system provides for scheduled send suggestions. When the system detects strong emotions such as negative emotions, the system proactively suggestions to the user to utilize a scheduled send feature for emails and chat messages to encourage the user to draft messages when emotionally charge, but delay sending the messages until the user is in a calmer state of mind to foster more thoughtful communication.

In some embodiments, the system provides for tone and language modulation. The system analyzes the user's tone of voice and body language to discern a current disposition of the user. If the system detects an aggressive, overly assertive, or negative tone, then the system will provide the user with a suggestion to tone down the text in emails or chats. This may include prompting the user to rephrases certain sentences, suggest the use of less confrontational language, or a suggestion to consider the recipient's perspective before sending.

In some embodiments, the system obtains various sensor data for generating content and augmenting actions. For example, the system may obtain various physiological signals from wearable devices such as smartwatches, dedicated sensors, a smartphone camera, a standalone camera, or sensor data from other types of sensors. The sensor data may include heartbeat information used to track a heart rate variability that is indicative of stress, excitement, or calmness. The sensor data may include temperature information where body temperature fluctuations correlate with emotional states. The sensor data may include other signals such as galvanic skin response, respiration rate, and sleep patterns.

In some embodiments, the system implements camera based expression recognition. The system controls a camera to capture facial expressions that are analyzed using image classification and emotion recognition algorithms for determining an emotional state of the user. The system controls a smartwatch with sensors capable of detecting subtle facial muscle movements as sensor data. The system implements gesture recognition functionality to identify user intent and emotional states through body language and hand gestures. The system implements object detection and image classification to understand the context of a user's environment and activities to enrich emotional and behavior analysis performed by the system. For example, object detection may be implemented to identify if a user is located in a stressful environment (e.g., texting while on a crowded subway train on a commute) or engaging in a relaxing activity (e.g., watching a movie), which can be analyzed to determine context for interpreting vitals and expressions.

In some embodiments, the system provides for emotionally intelligent message drafting assistance that goes beyond simple tone suggestions. The system can actively offer to rewrite phrases or sentences within emails or chat messages in real-time. For example, if anger or frustration is detected, then the system could suggest calmer or more neutral phrasing options directly within the message drafting window. The user could accept or reject the proposed re-writes.

In some embodiments, the system provides for preemptive pause and reflect prompts. Before sending a message when heightened emotions are detected, the system triggers a pause and reflect prompt to actively encourage the user to reconsider the message (e.g., “are you conveying your message as intended? Would scheduling this send be beneficial? Consider taking a moment before sending”).

In some embodiments, the system provides for recipient emotion prediction that leverages historical communication data and/or emotional profiles to predict how a recipient might emotionally react to a message. The system may provide a user with a potential emotional impact score or flag to prompt the user to adjust their message for better reception. The system may provide emotionally contextualized communication summaries. While reviewing past conversations, the system may generate and provide a summary to highlight the content and emotional context of the exchanges. For example, a summary may note instances where the user or recipient exhibited strong emotions.

In some embodiments, the system provides for emotionally adaptive content summarization. When a user browses articles or documents, the system dynamically adjusts the summarization style based on an emotional state of the user. If the user is stressed or overwhelmed, then the system may provide a short and more concise summary focusing on key takeaways. If the user is calmer or more engaged, then the system may provide more detailed and nuanced summaries.

In some embodiments, the system provides for interactive emotional content exploration where the user can discover content through an interface that provides content browsing based upon emotional themes of articles, videos, music, etc. The user could submit a query “uplifting news,” “calming documentaries,” or “energized playlists,” and the system may provide search results of content that corresponds to the emotional themes

In some embodiments, the system provides for emotionally triggered break reminders and content diversification. If prolonged negative emotions are detected while consuming specific types of content such as stressful news, the system can proactively suggest taking a break, switching to more positive content suggested by the system, and/or engaging in a completely different activity. The system may suggest diversifying content sources if there is bias detected for the content, such as recommending articles from different perspectives directly within a content viewing interface.

In some embodiments, the system provides for enhanced emoji and expression capabilities. The system provides emotionally animated and nuanced emojis such as animated emojis that dynamically reflect the intensity and subtlety of user emotions. For example, a happy emoji could subtly change its animation speed based on a detected level of joy.

In some embodiments, the system is capable of reformatting and/or standardizing emojis for different communication platforms.

In some embodiments, the system can extend emotional detection to photos and video libraries. The system could automatically tag and organize media files based upon emotions detected in faces within the media files so that users can search for and revisit memories associated with specific feelings (e.g., “show me photos from happy moments last summer”).

In some embodiments, the system provides for emotionally driven task prioritization and scheduling. The system integrates with task management and calendar applications to reprioritize tasks based upon a detected energy level and/or emotional state of a user. For example, less demanding tasks may be suggested when the user is stressed, and more engaging tasks could be prioritized during times of calm focus

In some embodiments, the system may provide for proactive wellbeing nudge and personalized interventions. Based upon long-term emotional trend analysis, the system may proactively suggest personalized well-being interventions, such as a reminder to take a break or hydrate, a suggested guided meditation session, a recommended type of music or song, and/or promoting social connection with contacts in a contact list if the user is detected as being lonely or isolated where a location of the user is detected as being in a single location for a threshold amount of time (e.g., the user has not left the house for 3 days).

In some embodiments, the system may provide for emotionally aware smart home integration. The system may connect to smart home devices such as over a Wi-Fi connection. Based upon a user's detected emotional state, the system may automatically adjust environmental factors such as lighting (e.g., dim the lights if the user is stressed), temperature (e.g., cool down a room if anger is detected), and music (e.g., play calming music when anxious) to create an emotionally supportive and responsive living environment.

In some embodiments, the system may provide for emotional check-in gamified prompts. The system may turn emotional journaling into a more engaging experience by introducing gamified emotional check-in prompts throughout the day. Users may earn points or virtual rewards for tracking (electronically journaling) their emotions to reflect on triggers and patterns. The system may provide for a visual and emotional timeline and/or analytics dashboard. The system may present a user with a visual timeline of the user's emotional fluctuations over time, highlighting patterns, triggers, and correlations with activities and events. The analytics dashboard may provide the user with insight into emotional trends for a comprehensive understanding of the user's emotional landscape.

In some embodiments, the system provides a comprehensive approach to combing physiological signals (e.g., heartbeat and temperature), expression recognition (e.g., images from cameras or smartwatches), gesture recognition, and/or object/image classification through multi-sensor data analysis functionality to provide a more accurate understanding a user's emotional state. The system leverages gesture recognition (e.g., MediaPipe) and advanced emotion artificial intelligence (AI) to accurately track the user's emotional state, and to understand patterns and trends of the user's emotional state.

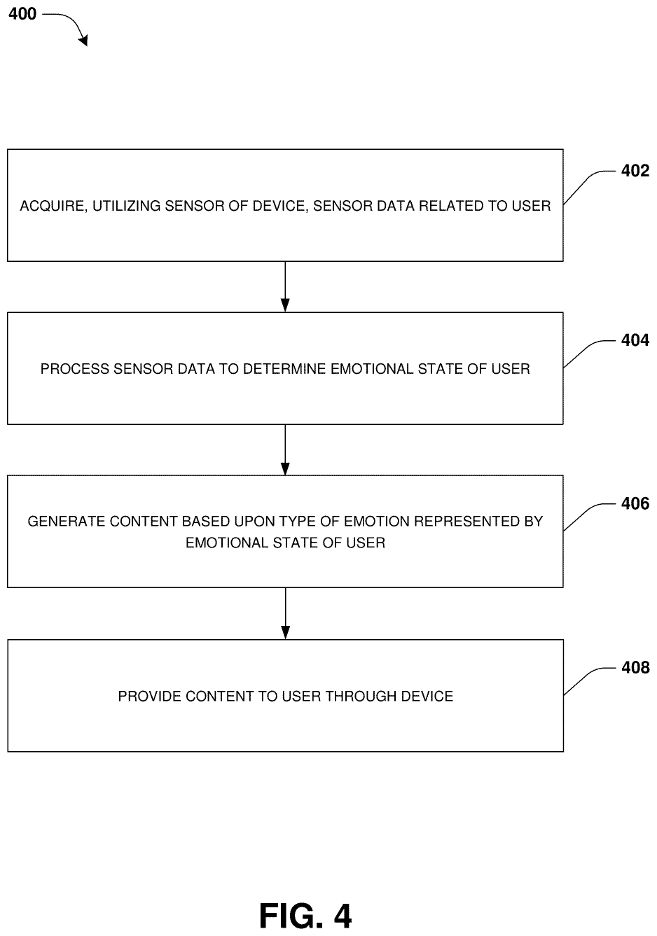

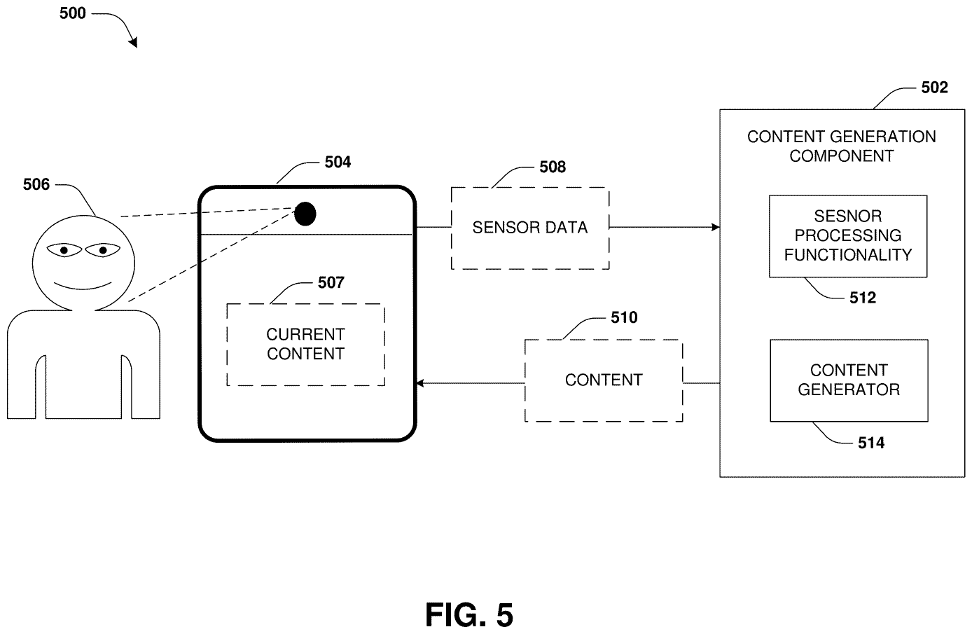

FIG. 4 is a flow chart illustrating an example method 400 for augmenting actions based upon detected user expressions, which is described in relation to the systems of FIGS. 5-18 . In some embodiments, a system 500 may include a content generation component 502 configured to perform the method 400 for augmenting actions based upon detected user expressions, such as augmenting email drafting actions, content browsing actions, chat message conversation actions, task prioritization and execution actions, video call actions, etc. In some embodiments, the content generation component 502 is hosted on a device 504 (e.g., the content generation component 502 may include programming code and instructions stored within memory or storage of the device 504, which is executed by a processor of the device 504), even though the content generation component 502 is illustrated as being external to the device 504 merely for illustrative purposes. In some embodiments, the content generation component 502 may be hosted external to the device 504, such as on a server or other computing device connected to the device 504 over a network.

The content generation component 502 includes sensor processing functionality 512 configured to acquire sensor data 508 from a sensor of the device, such a standalone camera, a camera of a smart phone, a sensor of a smartwatch or wearable device, etc. The content generation component 502 includes a content generator 514 configured to generate content for augmenting actions. The sensor processing functionality 512 and/or the content generator 514 may include machine learning models such as generative models or large language models, image processing functionality, object detection functionality, facial recognition and analyzing functionality, pattern recognition functionality, trend detection functionality, a content generation engine, a recommendation engine, functionality to process physiological signals (e.g., heartbeat, temperature, galvanic skin response, respiration rate, sleep patterns, etc.), image classification and emotion recognition algorithms, gesture recognition functionality, text and emoji generation functionality, artificial intelligence (AI) content generation functionality, content and media browsing functionality, gesture recognition such as MediaPipe, and/or functionality to access and modify an email interface, a chat interface, a calendar interface, a task interface, a smart device, etc.

A user 506 may use the device 504 to view current content 507 being displayed by the device 504. For example, the user 506 may be engaging in a chat conversation displayed through a chat interface as the current content 507. During operation 402 of method 400, the content generation component 502 acquires the sensor data 508 from the sensor of the device 504. The sensor data 508 may relate to the user, such as images of the user while interacting with the current content 507 displayed through the device 504 or the other performing other tasks such as walking around the house performing chores, working at a laptop, or commuting on a subway.

During operation 404 of method 400, the content generation component 502 processes the sensor data 508 to determine an emotional state of the user. For example, the sensor processing functionality 512 may execute various image classification, gesture recognition, and emotion recognition algorithms to determine the emotional state of the user, such as a frustrated emotional state (e.g., the user 506 may have facial expressions, tone of voice, gestures or movement, or other biometrics indicative of being frustrated).

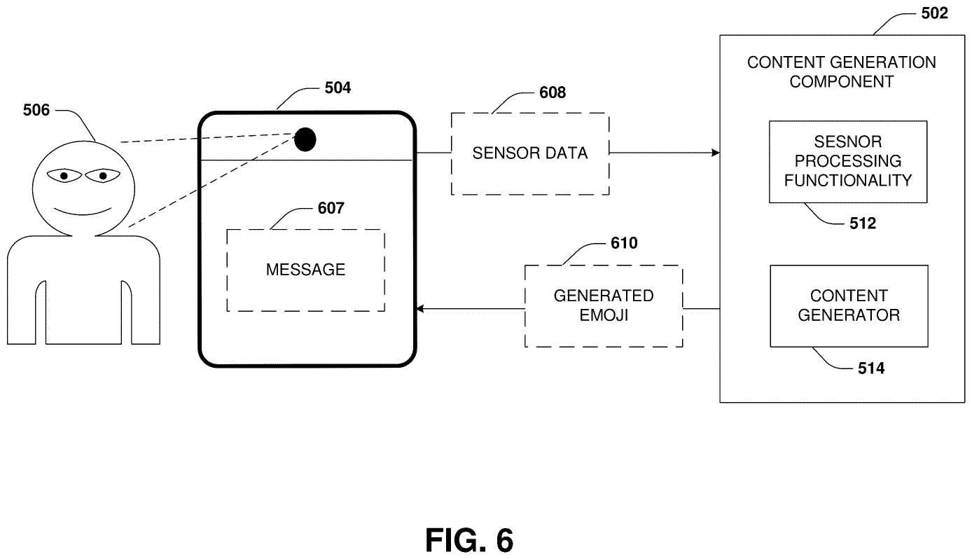

During operation 406 of method 400, the content generation component 502 generates content 510 based upon a type of emotion represented by the emotional state of the user. For example, the content generator 514 may create the content 510 as an emoji representing frustration. The content generator 514 may create the content 510 as replacement text for a chat message being composed by the user 506. The replacement text may have a less frustrated tone than the text of current text of the chat message. The content generator 514 may create the content 510 to include a suggestion regarding how a recipient may perceive the chat message. It may be appreciated that a variety different content may be generated, and that FIGS. 6-17 provide various example embodiments. During operation 408 of method 400, the content 510 is provided to the user 506, such as through display on an interface hosted by the device 504 (e.g., a chat interface through which the user is creating the chat message).

FIG. 6 illustrates the content generation component 502 acquiring sensor data 608 while the user 506 is writing a message 607 through the device 504. The sensor data 608 may relate to audio, video, images, or other biometric data obtained by sensors. The content generation component 502 may utilize the sensor processing functionality 512 to process the sensor data 608 to determine an emotional state of the user 506. For example, the user 506 may be identified as laughing or in a happy or silly mood based upon facial expressions and/or gestures identified from the sensor data 608 by the sensor processing functionality 512. Accordingly, the content generator 514 may generate a personalized emoji 610 based upon the facial expressions and/or gestures to reflect a type of emotion represented by the emotional state of the user, such as a silly emoji that may have a laughing animation. In this way, the personalized emoji 610 is presented to the user 506 for inclusion within the message 607.

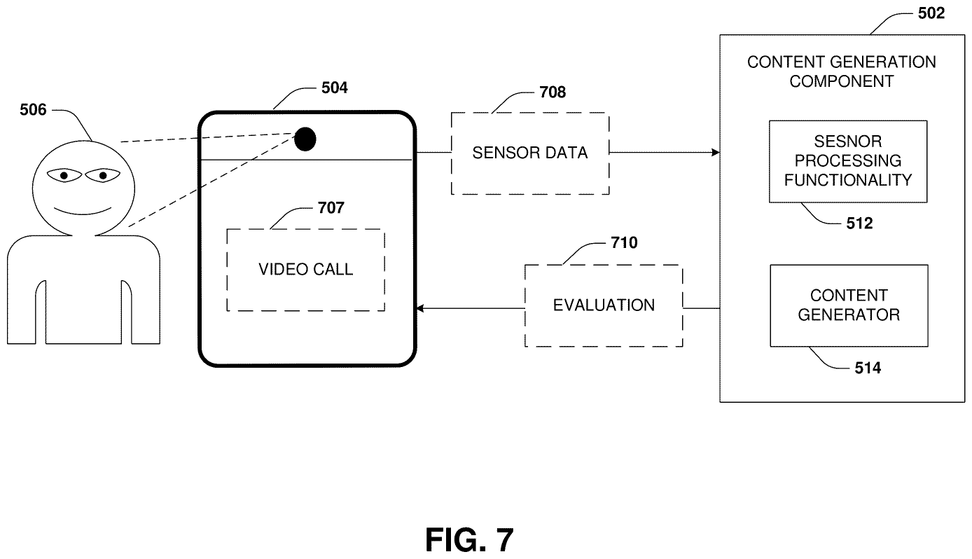

FIG. 7 illustrates the content generation component 502 acquiring sensor data 708 while the user 506 is participating in a video call 707 through the device 504. The sensor data 708 may relate to audio, video, images, or other biometric data obtained by sensors, such as in real-time during the video call 707. The content generation component 502 may utilize the sensor processing functionality 512 to process the sensor data 708 to determine an emotional state of the user 506. For example, the user 506 may be identified as acting stressed during the video call 707 based upon gestures and/or facial expressions identified from the sensor data 608 by the sensor processing functionality 512. In response to the sensor processing functionality 512 detecting a change in facial expression or gestures indicative of an emotion state change, the content generator 514 generates an evaluation 710 of a perceived emotional state of the user for the video call 707, such as where another participant of the video call 708 may notice a change from a normal emotional state to a stressed emotional state. The evaluation 710 of the perceived emotional state may be displayed to the user.

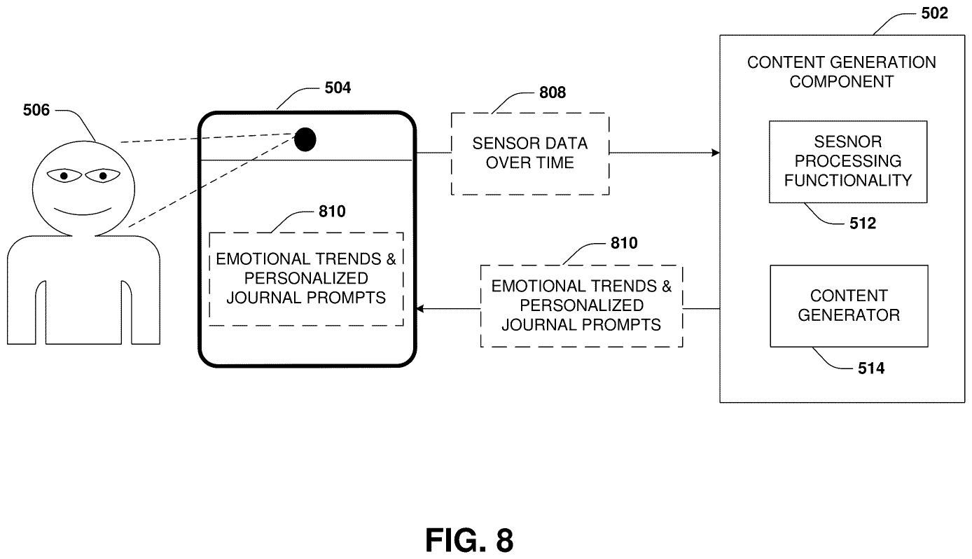

FIG. 8 illustrates the content generation component 502 acquiring sensor data 808 over time, such as images of the user. The sensor data 808 may relate to audio, video, images, or other biometric data obtained by sensors over time. The content generation component 502 may utilize the sensor processing functionality 512 to process the sensor data 808 to identify a typical facial expression, facial expression changes that differ from the typical facial expression, and/or an emotional baseline of the user (e.g., the user may be generally stressed throughout the day). The typical facial expression, the facial expression changes, and/or the emotional baseline of the user may be evaluated to detect shifts in emotional trends of the user that may be used to generate content 810, such as a notification of the shifts in emotional trends. In some embodiments, the images may be analyzed to construct an emotional journal correlating emotions of the user, timestamps of when the emotions were detected, and activities being performed by the user when the emotions were detected at times captured by the timestamps. In this way, the emotional journal may be provided as the content 810 to the user 506 with personalized journal prompts for the user 506.

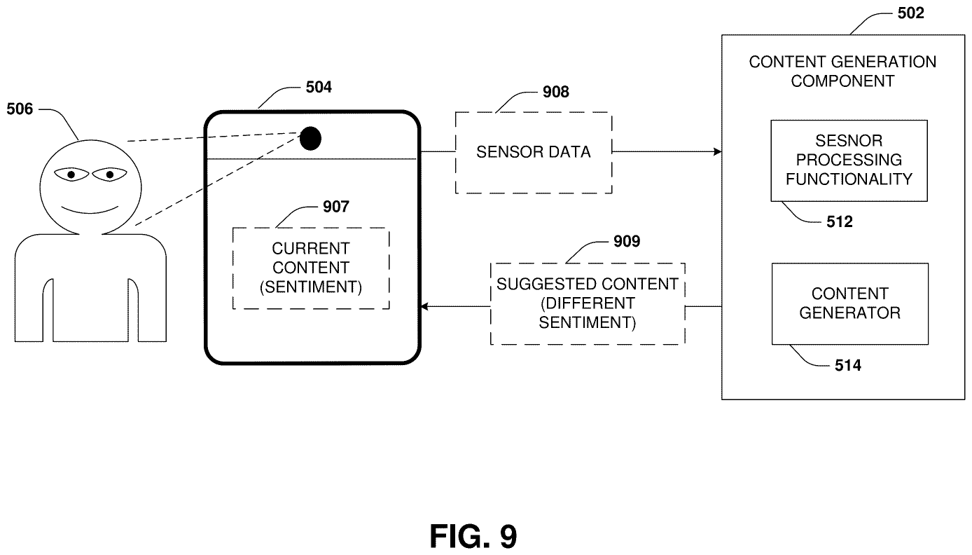

FIG. 9 illustrates the content generation component 502 acquiring sensor data 908 while the user 506 is consuming current content 907 through the device 504. The sensor data 908 may relate to audio, video, images, or other biometric data obtained by sensors. The content generation component 502 may utilize the sensor processing functionality 512 to process the sensor data 908 to determine a sentiment of the current content 907, such as a heavily biased news article. The content generator 514 may select and suggest content 909 that has a different sentiment, such as a neutral or opposite bias of the current content 907. The content 909 may be selected based upon a type of emotional represented by the emotional state of the user, such as where the heavily biased news article caused the user 506 to become frustrated, as determined from the sensor data 908. For example, the content 909 may include an article that may relax the user 506.

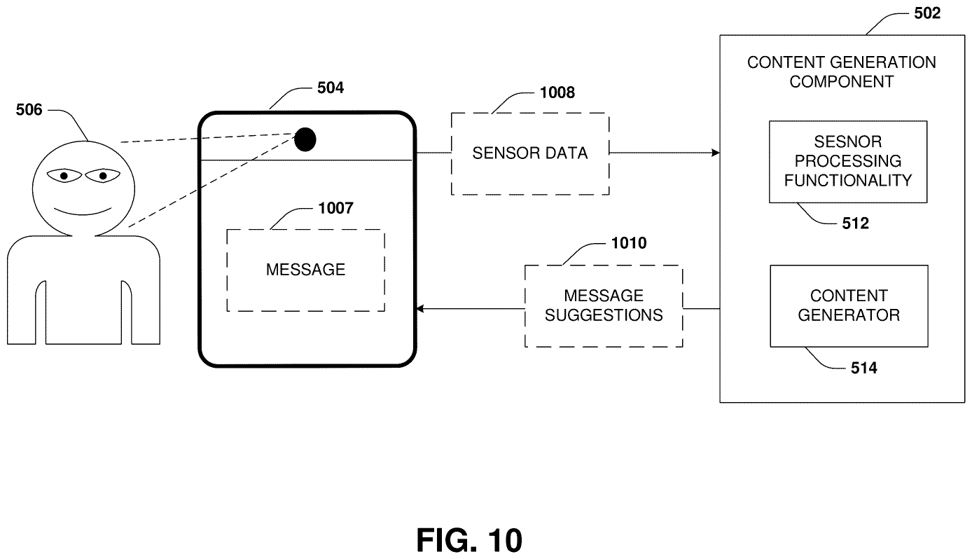

FIG. 10 illustrates the content generation component 502 acquiring sensor data 1008 over time, such as images of the user. The sensor data 1008 may relate to audio, video, images, or other biometric data obtained by sensors while the user is writing a message 1007. The content generation component 502 may utilize the sensor processing functionality 512 to process the sensor data 1008 to determine an emotional state of the user 506 while writing the message 1007, such as in real-time. The content generator 514 generates message suggestions 1010 based upon the emotional state of the user 506. In some embodiments, the message suggestions 1010 may include a command to dynamically adjust a message un-send time for the message 1007 based upon the user being detected as being frustrated or stressed based upon the sensor data 1008.

In some embodiments, the message suggestions 1010 may include a scheduled send feature to delay message sending. In some embodiments, the message suggestions 1010 may include a suggestion for the user to consider select wording or sentiment of the message 1007, such as a suggestion to rephrase a sentence that has a strong negative tone. In some embodiments, the message suggestions 1010 may include a notification for the user to reconsider the message 1007 based upon the emotional state of the user 506 being indicative of a heightened emotional state, such as anger or frustration. In some embodiments, the content generator 514 predicts a recipient reaction of a recipient to the message 1007 being composed by the user 506. The message suggestions 1010 may include potential emotional impact information based upon the predicted recipient reaction. In some embodiments, the message suggestions 1010 are provided to the user 506 in real-time during message composition by the user of the message 1007.

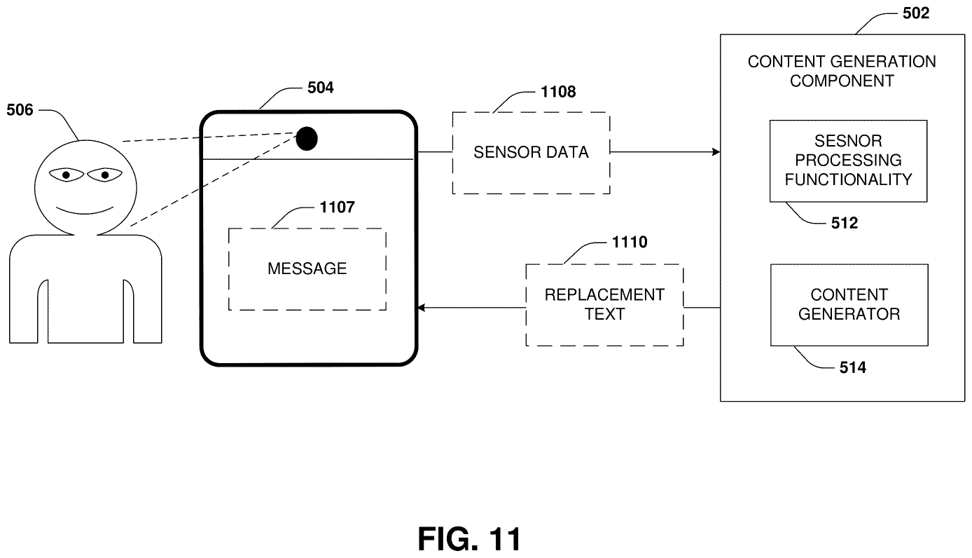

FIG. 11 illustrates the content generation component 502 acquiring sensor data 1108 over time, such as images of the user. The sensor data 1108 may relate to audio, video, images, or other biometric data obtained by sensors while the user is writing a message 1107. The content generation component 502 may utilize the sensor processing functionality 512 to process the sensor data 1108 to determine an emotional state of the user 506 while writing the message 1107, such as in real-time. The content generator 514 generated, in real-time during message composition by the user of the message 1107, replacement text 1110 to suggest to the user 506 for replacing current text within the message 1107 (e.g., a suggestion to replace an aggressively written sentence with a more tactful or neutral sentence).

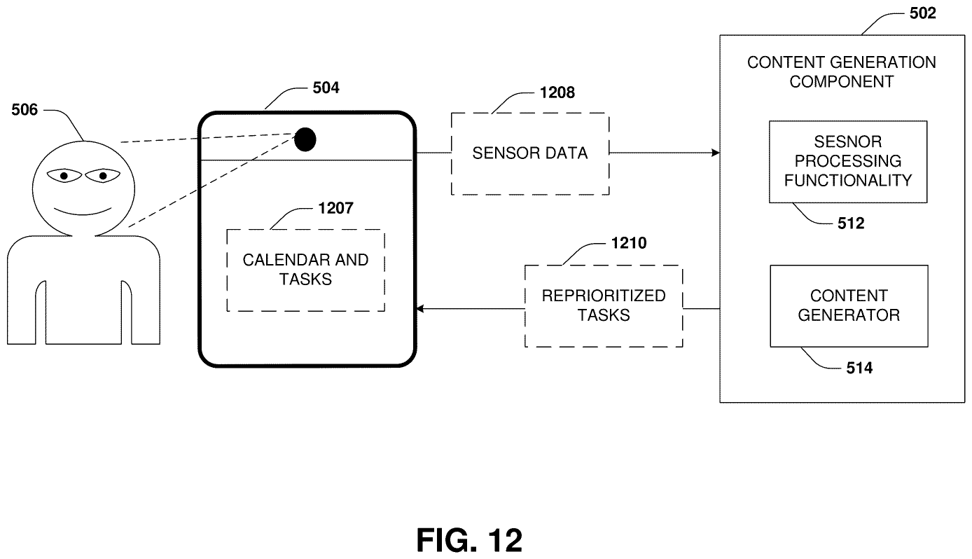

FIG. 12 illustrates the content generation component 502 acquiring sensor data 1208 over time. The sensor data 1208 may relate to audio, video, images, or other biometric data obtained by sensors. The content generation component 502 may utilize the sensor processing functionality 512 to process the sensor data 1208 to determine an emotional state of the user 506. The content generator 514 may reprioritize 1210 tasks of the user, such as tasks within a calendar and task interface 1207, based upon the emotional state of the user 506. In some embodiments, the content generation component 502 integrates with task management and calendar applications to reprioritize 1210 tasks based upon a detected energy level and/or emotional state of the user 506. For example, less demanding tasks may be suggested when the user 506 is stressed, and more engaging tasks could be prioritized during times of calm focus.

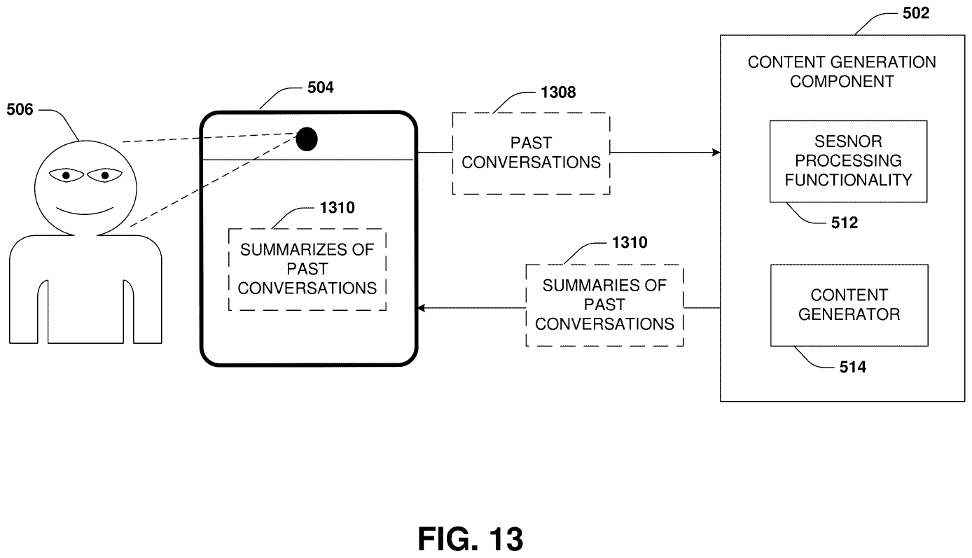

FIG. 13 illustrates the content generation component 502 acquiring past conversations 1308 by the user. The past conversations 1308 may relate to emails, text messages, social media comments, or any other text that is written or received by the user 506. The content generation component 502 may evaluate the past conversations 1308 to generate summaries 1310 of the past conversations 1308. The summaries 1310 may include emotional context for the past conversations 1308 (e.g., an angry email, a heartfelt conversation, etc.). The content generator 514 may generate the summaries 1310 to highlight content and emotional context of the past conversations 1308. For example, a summary may note instances where the user 506 or recipient exhibited strong emotions.

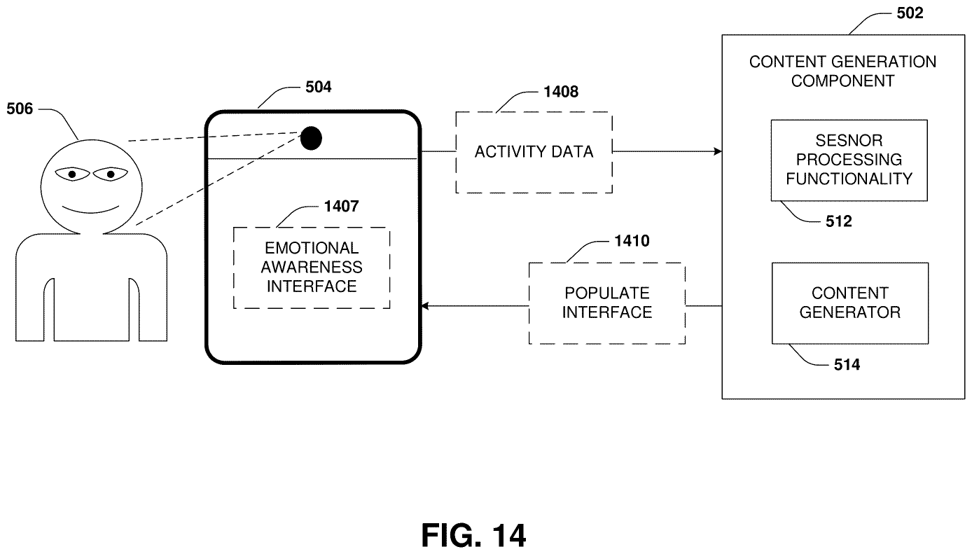

FIG. 14 illustrates the content generation component 502 acquiring activity data 1408 of the user 506 performing activities while emotional patterns are being tracked for the user 506 (e.g., the user calming reading a book, the user excited over a package arriving, the user stressed while on a busy commute, etc.). The content generation component 502 may generate an emotional awareness interface 1407 that is populated 1410 with a virtual emotional timeline of the emotional patterns. The emotional awareness interface 1407 correlates the emotional patterns with activities and events identified from the activity data 1408. In some embodiments, the emotional awareness interface 1407 may be populated 1410 with a timeline visually displaying when the user had certain emotional states while performing certain activities, such as stress during a morning commute, anxiety during an evening commute, calm while reading a book during the evening, etc.).

In some embodiments, the content generation component 502 may populate 1410 the emotional awareness interface 1407 with an analytics dashboard of emotional trends of the user 506 (e.g., the user is usually calm while reading, the user is often stressed while commuting, etc.). In some embodiments, the content generation component 502 may populate 1410 the emotional awareness interface 1407 with gamified emotional check-in prompts. The content generation component 502 may turn emotional journaling into a more engaging experience by providing the gamified emotional check-in prompts throughout the day. The user 506 may earn points or virtual rewards for tracking (electronically journaling) their emotions to reflect on triggers and patterns.

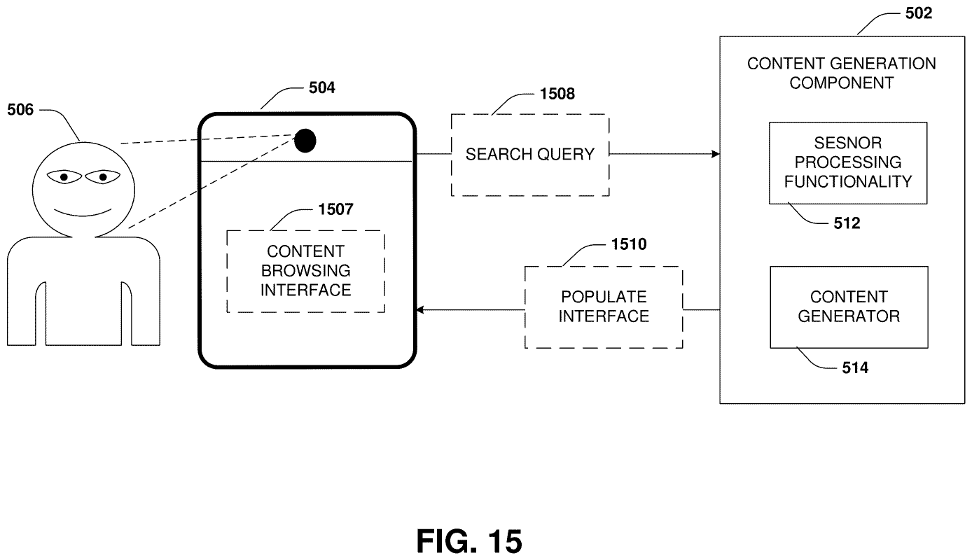

FIG. 15 illustrates the content generation component 502 providing the user 506 with a content browsing interface 1507 that is populated 1510 with content in response to a search query 1508 received by the user 506. In particular, the content generation component 502 may identify emotional themes for content (e.g., a peaceful image, an angry article, an inspirational story, etc.). In this way, the user 506 may search for content matching certain emotional themes, such as inspirational articles.

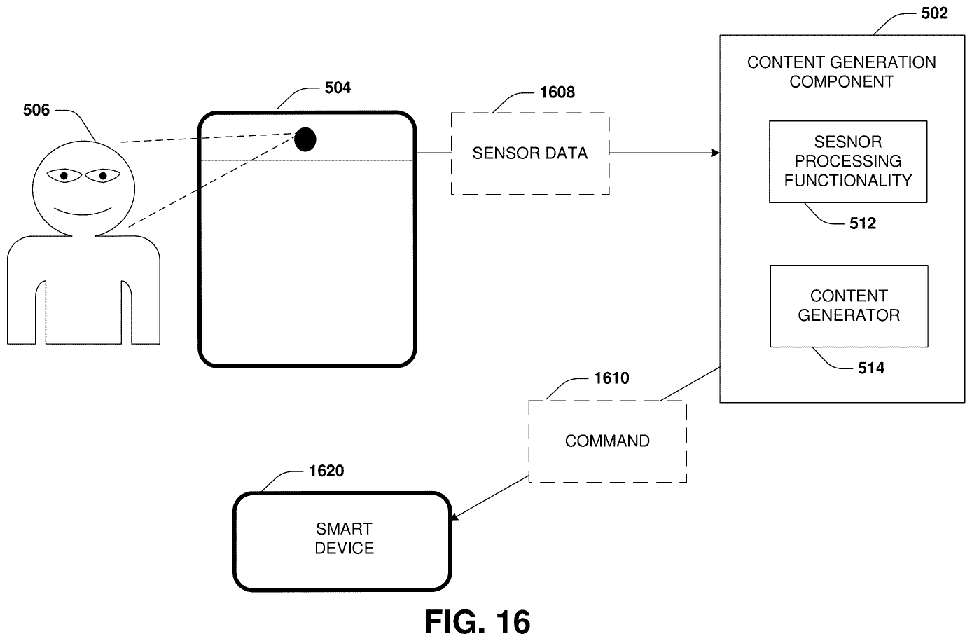

FIG. 16 illustrates the content generation component 502 acquiring sensor data 1608 from the device 504. The sensor data 1608 may relate to audio, video, images, or other biometric data obtained by sensors. The content generation component 502 may utilize the sensor processing functionality 512 to process the sensor data 1608 to determine an emotional state of the user 506. For example, the user 506 may be identified as being frustrated. Accordingly, the content generation component 502 may generate a control command 1610 to control a smart device 1620, such as to turn on/off or dim lights, turn on/off or change music being played through a speaker, increase or decrease temperature through a thermostat, etc.

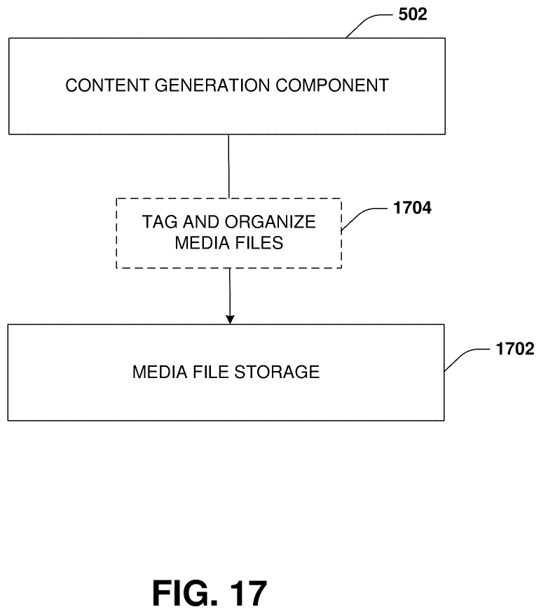

FIG. 17 illustrates the content generation component 502 tagging and organizing media files stored within media file storage 1702 based upon emotions detected within the medial files. In particular, image analysis and emotion recognition functionality may be used to evaluate faces or gestures of people depicted by the media files to detect emotions associated with the people. The media files are tagged and organized 1704 for searching based upon the emotions depicted by the faces or identified from the gestures. In this way, a user may search the media file storage 1702 to identify media files tagged with certain emotions such as angry images.

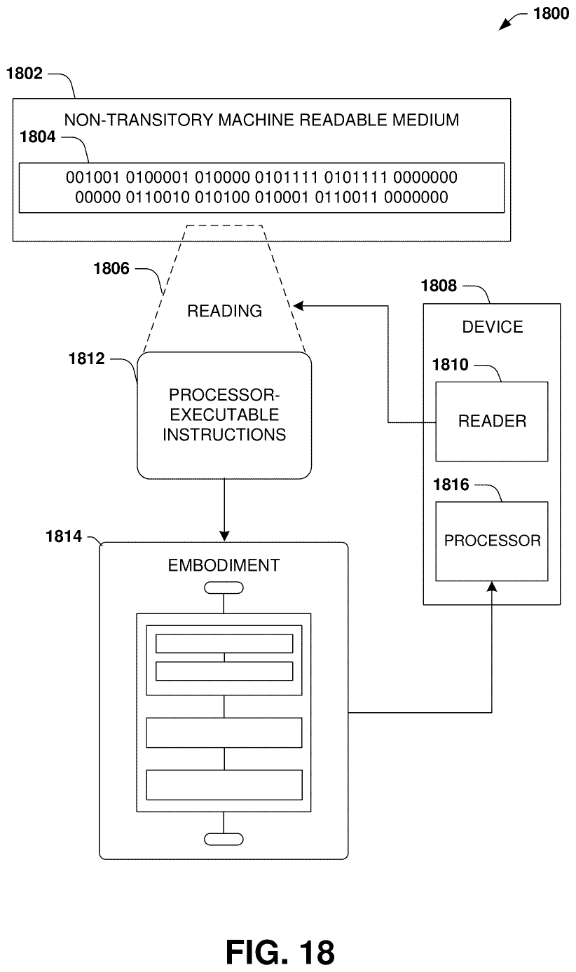

FIG. 18 is an illustration of a scenario 1800 involving an example non-transitory machine readable medium 1802. The non-transitory machine readable medium 1802 may comprise processor-executable instructions 1812 that when executed by a processor 1816 cause performance (e.g., by the processor 1816) of at least some of the provisions herein (e.g., embodiment 1814). The non-transitory machine readable medium 1802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 1802 stores computer-readable data 1804 that, when subjected to reading 1806 by a reader 1810 of a device 1808 (e.g., a read head of a hard disk drive, or a read operation invoked on a solid-state storage device), express the processor-executable instructions 1812. In some embodiments, the processor-executable instructions 1812, when executed, cause performance of operations, such as at least some of the example method 400 of FIG. 4, for example. In some embodiments, the processor-executable instructions 1812 are configured to cause implementation of a system, such as at least some of the example system 500 of FIG. 5, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
acquiring, utilizing a sensor of a device, sensor data related to a user;
processing the sensor data to determine an emotional state of the user;
generating content based upon a type of emotion represented by the emotional state of the user; and
providing the content to the user through the device.

2. The method of claim 1, comprising:
detecting the sensor data as facial expressions of the user;
generating a personalized emoji reflecting the type of emotion represented by the emotional state of the user; and
providing the personalized emoji as the content to the user for selective inclusion within user generated content.

3. The method of claim 1, comprising:
detecting the sensor data as facial expressions of the user during a video call;
in response to detecting a change in facial expression indicative of an emotional state change, generating an evaluation of a perceived emotional state of the user for the video call; and
displaying the evaluation to the user as the content.

4. The method of claim 1, comprising:
analyzing images of the user over time to identify a typical facial expression, facial expression changes, and an emotional baseline of the user;
evaluating the typical facial expression, the facial expression changes, the an emotional baseline of the user to detect shifts in emotional trends of the user; and
generating a notification of the shifts in emotional trends as the content.

5. The method of claim 1, comprising:
analyzing images of the user over a time period to construct an emotional journal correlating emotions of the user, timestamps, and activities of the user; and
providing the emotional journal as the content to the user with personalized journal prompts for the user.

6. The method of claim 1, comprising:
evaluating current content being consumed by the user when the sensor data is obtained to determine a sentiment of the current content; and
selecting the content to have a different sentiment than the sentiment of the current content based upon the type of emotion represented by the emotional state of the user.

7. The method of claim 1, comprising:
dynamically adjusting an un-send time for messages based upon the emotional state of the user.

8. The method of claim 1, comprising:
suggesting a scheduled send feature to delay message sending based upon the emotional state of the user.

9. The method of claim 1, comprising:
generating the content as a suggestion for the user to consider select wording or sentiment of a message being composed by the user based upon the emotional state of the user.

10. A non-transitory machine-readable medium having stored thereon processor-executable instructions that when executed cause performance of operations comprising:
acquiring, utilizing a sensor of a device, sensor data related to a user;
processing the sensor data to determine an emotional state of the user;
generating content based upon a type of emotion represented by the emotional state of the user; and
providing the content to the user through the device.

11. The non-transitory machine-readable medium of claim 10, the operations comprising:
generating, in real-time during message composition by the user, the content to include replacement text for a message being composed by the user.

12. The non-transitory machine-readable medium of claim 10, the operations comprising:
generating, in real-time during message composition by the user, the content to a notification for the user to reconsider the message based upon the emotional state being indicative of a heightened emotional state.

13. The non-transitory machine-readable medium of claim 10, the operations comprising:
predicting, in real-time during message composition by the user, a recipient reaction to a message being composed by the user; and
generating the content to include potential emotional impact information based upon the recipient reaction.

14. The non-transitory machine-readable medium of claim 10, the operations comprising:
evaluating past conversations by the user to generate summaries that include emotional context for the past conversations; and
generating the content to include the summaries.

15. The non-transitory machine-readable medium of claim 10, the operations comprising:
providing the content to include an emotional awareness interface including at least one of a visual emotional timeline of emotional patterns and correlated events and activities, an analytics dashboard of emotional trends of the user, or gamified emotional check-in prompts.

16. A computing device comprising:
a processor; and
memory comprising processor-executable instructions that when executed by the processor cause performance of operations comprising:
acquiring, utilizing a sensor of a device, sensor data related to a user;
processing the sensor data to determine an emotional state of the user;
generating content based upon a type of emotion represented by the emotional state of the user; and
providing the content to the user through the device.

17. The computing device of claim 16, the operations comprising:
reprioritizing tasks of the user based upon the emotional state of the user.

18. The computing device of claim 16, the operations comprising:
controlling a smart device based upon the emotional state of the user, wherein the smart device is controlled to change at least one of lighting, temperature, or music.

19. The computing device of claim 16, the operations comprising:
providing the user search a content browsing interface providing content based upon emotional themes.

20. The computing device of claim 16, the operations comprising:
tagging and organizing media files based upon emotions detected within faces depicted by the media files.
